(19) United States
(12) Patent Application Publication
(10) Pub. No.: US 2011/0274543 A1
(43) Pub. Date: Nov. 10, 2011

(54) Wind Turbine with Status Monitoring System

(76) Inventor: Matthias WOHLLEB, Aachen (DE)

(21) Appl. No.: 13/092,202

(22) Filed: Apr. 22, 2011

(30) Foreign Application Priority Data
May 6, 2010 (DE) 10 2010 019 644.4

(51) Int. Cl. F03D 11/00

(52) U.S. Cl. 416/61

(57) ABSTRACT

A wind turbine with a status monitoring system is provided. The wind turbine with the status monitoring system includes a generator with a generator coil, a control unit and a sensor connected to the control unit. A disconnection element, controlled by the control unit depending on the sensor, is arranged in a high-voltage line from the generator coil to the power network. A line connecting the control unit to the generator coil has integrated line monitoring.

### CROSS REFERENCE TO RELATED APPLICATIONS

This application claims priority of European Patent Office application No. 10 2010 019 644.4 DE filed May 6, 2010, which is incorporated by reference herein in its entirety.

### FIELD OF INVENTION

The invention relates to a wind turbine with a status monitoring system and to a status monitoring system for a wind turbine. The invention is particularly designed to protect the electrical systems and the wind turbine as a whole.

### BACKGROUND OF INVENTION

A wind turbine uses a generator in order to convert rotational energy into electrical energy. The electrical energy is usually output as 3-phase high voltage. A coil or winding of the generator delivers electrical energy when the rotor turns. The speed of rotation determines the frequency of the alternating currents in the coils.

The frequencies of the three phases must be stabilized for circumstances in which the generator breaks down or is removed or for a change in the wind direction. When a voltage drop or brownout begins the generator can become magnetized, which can lead to a power spike. This sudden power spike can lead to the transmission which is connected to the generator becoming worn or damaged.

Stabilization means such as thyristors for example are used to smooth out these power spikes in the form of unstable frequencies in all phases into a stable state. The frequencies are stabilized by switching on and switching off the thyristors. A control unit, with a processor or microprocessor for example, handles the control of the thyristors. The thyristors allow a continuous regulation of the electrical current.

The control unit receives data from sensors which are arranged on major components of the wind turbine, such as the generator, the main bearing, the transmission or the frame of the gondola for example. The sensors are usually connected to the control unit by means of coaxial cables. The control unit, the sensors and the thyristors form a status monitoring system. The status of the system can be transmitted to a control console, where the data is analyzed. The data can be transmitted by means of a GSM message, which is sent every ten seconds for example.

The article entitled “Protection for High-Voltage Systems”, ATZ Technology 6/2007 (December 2007), pages 27 to 28, describes a protection system for a high-voltage cable of hybrid automobiles. For a high-voltage cable with an integrated sensor critical states such as mechanical damage to the outer sleeve, short circuits and local overheating can be detected. The integrated sensor transmits the information to a detector unit which can switch off the high-voltage supply for this cable before a critical situation arises.

### SUMMARY OF INVENTION

The underlying object of the invention is to further improve the safety of a wind turbine, especially of the electronic components.

This object is achieved by the features of the claims respectively. Advantageous developments of the invention are described in the dependent claims.

In accordance with a first aspect of the invention a wind turbine with a status monitoring system has a generator with a generator coil, a control unit, a sensor connected to the control unit and a disconnection element able to be controlled by the control unit depending on the sensor in a high-voltage line from the generator to the power network. A line connecting the control unit with the generator coil has integrated line monitoring. The lines themselves can now also be monitored and protected with the invention. A new level of safety is thus achieved. Previously the data from sensors could be processed, now the connection to the sensors and further lines can also be monitored. Signal lines and high-voltage lines can be monitored. A further advantage is that the maintenance intervals can be longer because the wind turbine can better be kept within a defined status range and thus no disproportionate wear situations can occur. Many errors can be detected before they reach a critical level. Appropriate countermeasures such as disconnecting the generator from the power network for example can be immediately initiated. The line monitoring information flows into a status model, which means that to a certain extent it is thus used globally and not only locally for the line to be monitored. Accordingly the line monitoring information of a specific line can be used in order to initiate countermeasures in an entirely different area of the system.

A line connecting the control unit to the sensor can have integrated line monitoring. This makes it possible to monitor and protect the line to the sensor. This means that, in addition to monitoring by the sensor, the connection to the sensor is also monitored, which increases the safety of the system. The line monitoring can be used for all sensors or for a selected important group.

The sensor can have a signal input for receiving information in respect of line monitoring. The sensor receives the signal or the signals of the line monitoring and monitors the line itself. In addition to the original sensor signals the sensor processes the signals of the line monitoring and in the event of an error signals said error to the control unit. This can be merely an “error present” message or can be a specific error message. The specific error message can for example contain the precise error location, the cause and/or the importance of the error. The error message can be transmitted as a coded message.

A line connecting the control unit with the disconnection element can have integrated line monitoring. This allows monitoring of the line to the disconnection element which is important for safety, which in an emergency is intended to disconnect the generator from the power network. In the event of a line defect measures such as restricted operation or immediate disconnection can be initiated. Dangers can be detected in some cases even prior to the defect. The endangered components can then be protected against damage by suitable measures such as switching off or shutting down individual components.

The wind turbine can have a brake for the wind turbine and a line connecting the control unit to the brake can have integrated line monitoring. If during the operation of the generator the connection to the power network is interrupted, because of an error in a power line for example, the wind turbine accelerates. To avoid this, the control unit activates aerodynamic and/or mechanical brakes. The safety of this important subsystem is increased by the line monitoring since now errors in the signal transmission to and from the brake are detected and the appropriate measures can be taken.

The control unit can have a signal input for the line with integrated line monitoring for receiving information in respect of the line monitoring. This means that the control unit can receive the signal or the signals of the line monitoring and evaluate them directly. For sensors the control unit instead receives two signals, one from the sensor and a further signal from the line monitoring. A number of signals and signal inputs can also be provided per sensor or per other system connected to the control unit. Thus the power line for the sensor can also be equipped with integrated line monitoring. With bidirectional signal traffic with two separate lines both lines can have integrated line monitoring. Each line monitoring can be assigned its own signal input in the control unit so that error messages are to a certain extent assigned to the lines per hardware. Errors can be assigned to the corresponding lines by signal encoding if for example only one or a few signal inputs are provided on the control unit. The monitoring and evaluation of the signals by the control unit allows flexible approaches and a fast reaction to error events since the control unit instigates the measures to be taken.

The line monitoring can have an integrated sensor. This sensor is in the line, ideally contained within the shroud of the line, and monitors the line for example for damage to the outer skin, short circuits and overheating. A number of sensors specialized for specific monitoring tasks for example can also be used for each line. Monitoring of the connections (for example plugs) at the line ends can likewise be implemented. The sensor can be arranged on the outside of the line. This enables most faults or errors to be discovered before the line lying further inwards is damaged. Bus systems can also be equipped with the integrated line monitoring.

The integrated sensor can have a conductive layer which is wound in the form of a spiral around the line core. An insulator can be arranged between the line core and the conductive layer. This simple structure allows good monitoring with low manufacturing costs.

The line connecting the control unit to the generator coil can comprise part of the high-voltage line. As well as signal lines the entire high-voltage line or a part thereof can also be equipped with integrated line monitoring. Thus the area of the line which transmits energy generated by the generator can be monitored and protected.

The high-voltage line from the generator coil to the disconnection element can have integrated line monitoring. This means that an inner circle is monitored to a certain extent which, viewed from the network, is located beyond the disconnection elements.

The wind turbine can have three generator coils and three high-voltage lines, each with a disconnection element. This allows simple use in a three-phase alternating current system (also referred to as AC) which is in widespread use in electrical energy supply.

In accordance with a second aspect of the invention, a status monitoring system for a wind turbine as described above has a control unit, a sensor connected to the control unit, a disconnection element able to be controlled by the control unit depending on the sensor in a high-voltage line from the generator coil to the power network and a line connecting the control unit to the generator coil with integrated line monitoring. A status monitoring system of this type can be incorporated directly during manufacturing into a wind turbine or can be retrofitted later.

### BRIEF DESCRIPTION OF THE DRAWINGS

The invention is explained below in greater detail with reference to the drawings, in which:

FIG. 1 shows a block diagram of a status monitoring system for a wind turbine.

FIG. 2 shows a wind turbine with a status monitoring system.

The drawings merely serve to explain the invention and do not restrict it. The drawings and the individual parts are not necessarily true-to-scale. The same reference characters identify the same or similar parts.

### DETAILED DESCRIPTION OF INVENTION

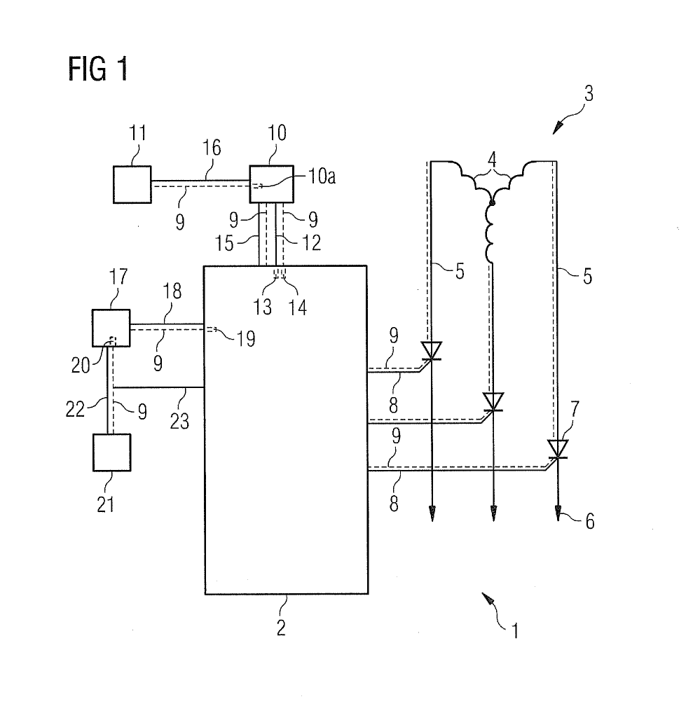

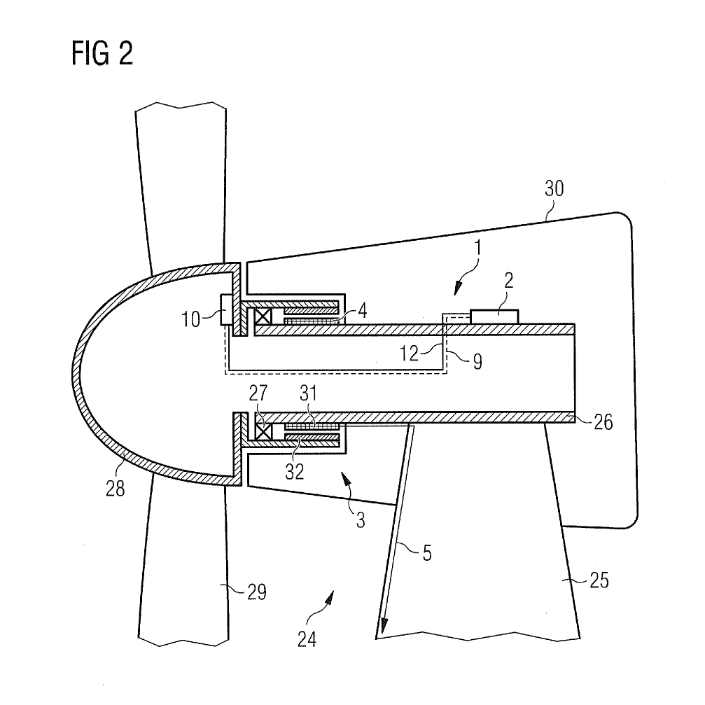

FIG. 1 shows a status monitoring system 1 for a wind turbine as shown in FIG. 2 for example. The status monitoring system 1 comprises a control unit 2 with a computer, microcontroller or a similar processing unit. The control unit 2 analyses received data with particular algorithms which can be programmed in hardware and/or software. Watchdogs, i.e. internal checking algorithms, can be employed for monitoring the calculations. Based on information newly arriving and information already present in the control unit 2, the control unit 2 calculates a status model of the wind turbine. On the basis of the status model the control unit 2 detects critical situations or errors and initiates appropriate countermeasures. The control unit 2 can also be a hierarchically subordinate controller such as a generator controller for example. In this case the status model at least does not execute completely on the generator control unit. The generator control unit can instead be a component of the status model. The calculation runs on a central computer, arranged in the wind turbine or the control console, or on distributed computers.

The control unit 2 has a communication interface such as a GSM modem for example in order to send messages, continuously or at least in the event of an error, to a control console or control center. The control unit can also receive messages so that activation of the control unit 2 from the control console is possible. The programming of the control unit 2 can be such that for specific situations or errors, the control unit 2 does not act independently but sends a message to the control console, receives an instruction from the control console and subsequently executes said instruction.

A generator 3 of the wind turbine has three generator coils or windings 4 for a three-phase alternating current type of energy transmission system. The generator coils 4 are each connected by a high-voltage line 5 to a power network 6. In the high-voltage line further elements such as control electronics or converters for example can be intermediately connected before the network.

Present in each high-voltage line 5 is a disconnection element 7 in the form of a thyristor. The thyristor is connected via a control line 8 to the control unit 2, so that this unit can control the disconnection element 7. The disconnection elements 7 can be used on the one hand for stabilizing the frequencies of the three phases and on the other hand for disconnecting the generator 3 from the network 6. In both cases the disconnection elements 7 are controlled by the control unit 2.

The status monitoring system 1 comprises integrated line monitoring 9 for selected lines or sections of lines. The integrated line monitoring 9 monitors the assigned line for conditions such as damage, for example mechanical or chemical by acids or gases, short circuits to ground or by overheating as a result of lightning strikes, discharges or fire for example.

For this purpose the integrated line monitoring 9 contains a sensor integrated into the line which is arranged on an outer area of the line in order to detect possible damage or dangers before they reach the line lying further within. The integrated sensor is heat-sensitive in order to detect an overheating situation.

The sensor can have a conductive layer which is wound in the form of a spiral around the line core. An insulator can be arranged between the line core and the conductive layer. By monitoring the electrical characteristics of the conductive layer deductions can be made about the respective situation.

The integrated line monitoring 9 is first described using as examples the control line, which can also be operated bidirectionally, and the section of the high-voltage line 5 lying between the disconnection element 7 and the generator coil 4. These areas are provided with integrated line monitoring 9. These sections (on all three phases) are important for the status monitoring system, since the generator is to some extent the heartbeat of the electrical system. The control unit 2 is directly connected to the generator coil 4 and to internal sensors of the generator not shown in the diagram by these lines. As an alternative the generator coil 4 and the internal sensors of the generator 3 can also be connected to the control unit 2 via additional separate lines (not shown) which then likewise have an integrated line monitoring.

The controller 2 obtains from the generator coils 4 and the internal sensors of the generator items of information such as information about voltage, current and frequency of the three phases and the temperature of the generator 3.

Further sensors, two sensors 10 and 11 are shown as typical and non-restricting examples, deliver data to the controller 2 about aspects such as the wind speed, the direction of the wind adjustment system, the rotational speeds of the shaft running slowly and the shaft running quickly, the temperatures of transmission oil and transmission bearings. Various hydraulic circuits, hydraulic pressure levels, valve functions, brake saddles of mechanical brakes and also emergency brakes are likewise monitored with sensors and transmit corresponding sensor data to the control unit 2.

The sensor 10 is connected to the control unit 2 by means of a sensor line 12 for transmission of sensor data, such as measurement data for example. The sensor line 12 contains integrated line monitoring 9. The control unit 2 has a first signal input 13 for the sensor line and a second signal input 14 for the line monitoring 9. Thus the sensor data and the information of the line monitoring are received separately by the control unit 2 and then processed accordingly.

An output line 15 connects the control unit 2 to the sensor 10. The output line 15 is used for transmission of data from the control unit 2 to the sensor 10. For example configuration data can be transmitted to the sensor 10. The output line 15 likewise contains integrated line monitoring 9 in order to monitor the status of and possible damage to the output line 15.

The sensor 11 is connected via an intermediate line 16 to the sensor 10, which is likewise equipped with line monitoring 9. This sensor 11 is connected indirectly to the control unit 2, namely via the sensor 10. The sensor 10 has a signal input 10a, to which the intermediate line 16 is connected in order to receive the line monitoring information. The sensor 10 handles the monitoring and evaluation of the sensor 11 and the line monitoring 9 of the intermediate line 16 and forwards this data via the signal line 12 to the control unit 2 for evaluation 2. The sensor 11 is to a certain extent a sub-sensor of the sensor 10. The data from the sensor 10 to the control unit 2 can be encoded in order to reduce the wiring complexity. Instead of an individual sensor line a number of parallel lines or a bus system can also be used, which is then likewise equipped with line monitoring.

A brake 17 for the wind turbine, for example a mechanical or aerodynamic brake, has one or more internal sensors which transmit data about the status of the brake 17 to the control unit 2. To this end the brake 17 is connected by a line 18 to the control unit 2. The line 18 is provided with line monitoring 9. The control unit 2 has a third signal input 19 for the line 18 with integrated line monitoring 9. The line monitoring information 9 is directed to a signal input 20 of the brake 17, treated there as a sensor signal and transmitted like the sensor data 17 to the control unit 2. The data can be encoded. The joint transmission of sensor data and line monitoring information is not only possible for actuators, for which the brake 17 is shown as an example, but also for sensors.

The brake 17 is supplied by an energy source 21 with electrical energy 21 and is connected to the energy source for this purpose by means of a supply line 22. The supply line 22 contains a line monitoring system 9 to monitor it. The line monitoring 9 is connected by a signal line 23 to the control unit 2, in order to transmit line monitoring information directly to the control unit 2. The integrated line monitoring 9 is thus connected directly to the control unit 2 here, although the line 22 with the integrated line monitoring 9 is not connected to the control unit 2. This line 22 can also be equipped with integrated line monitoring.

A plurality of lines with different configurations is shown, which all have integrated line monitoring 9 available. Naturally lines without line monitoring can also be connected to the control unit 2 or to other elements of the status monitoring system 1.

The status monitoring system 1 comprises the control unit 2, the sensors 10 and 11, the actuator 17, the disconnection elements 7 and also the line monitoring systems 9. The generator coils 4 as well as the internal generator sensors (not shown in the diagram) can likewise be counted as part of the status monitoring system 1 since data such as current and voltage is measured directly at them.

The control unit 2 receives information continuously and/or in the event of an error from the sensors and line monitoring systems, routes this to the status model and makes decisions based on the status model. These decisions can be forwarded to a control console and/or implemented directly, for example with actuators such as the brake 17 or the disconnection elements 7.

FIG. 2 shows a wind turbine 24 which is equipped with the status monitoring system 1. The wind turbine 24 has a tower 25 which is anchored in the ground and can be over 100 meters in height. The main shaft 26 is arranged at the top end of the tower 25. Arranged on the front end of the main shaft 26 is the main bearing 27 which movably connects the fixed main shaft 26 to a rotating rotor hub 28. Two or more rotor blades 29 are attached to the rotor hub 28. A gondola 30 encloses the fixed components on the upper end of the tower 25.

The generator 3 has a fixed stator 31 with the generator windings or coils 4 and a rotating rotor 32. The coils 4 can also be arranged on the rotor 32. High-voltage lines 5 run from the generator coils 4 through the tower 25 to the power network 6.

For reasons of clarity the status monitoring system 1 is shown in FIG. 2 with only a few components. All and also further additional components from the detailed diagram in FIG. 1 can also be transferred to FIG. 2. Accordingly the statements made in relation to FIG. 1 also apply for FIG. 2.

The control unit 2 is attached to the main shaft 26 and connected to sensors 10 by means of a sensor line 12 with integrated line monitoring 9. This is shown by way of example for a sensor 10 which is arranged in the rotor hub 28 and for example monitors the hydraulic system for adjusting the rotor blade 29. The sensor line 12 can for example contain a slip ring at the transition between fixed and rotating parts. This slip ring and also plugs or other connectors of the lines can be connected to the integrated line monitoring, for example by a separate plug-in or screw connection which is arranged in parallel to the actual connection of the line.

The control unit 2 processes the received sensor data and line monitoring information and controls actuators such as brakes and disconnection elements, which are not shown in the diagram the reasons of clarity.

If an error situation or a critical state preceding an error occurs, such as for example mechanical damage to the high-voltage line 5, the control unit 2 immediately activates the disconnection element 7 of the corresponding high-voltage line 5 or all 3 disconnection elements 7 in order to avoid electrical discharges or short-circuits. A message about the error and about measures taken is sent to the control console so that a repair can be initiated.

1.-12. (canceled)

13. A wind turbine with a status monitoring system, comprising:
a generator including a generator coil;
a control unit;
a sensor connected to the control unit; and
a disconnection element, controlled by the control unit which depends on the sensor, disposed in a high-voltage line from the generator coil to a power network,
wherein a first line connecting the control unit to the generator coil includes integrated line monitoring.

14. The wind turbine as claimed in claim 13, further comprising a second line connecting the control unit to the sensor which includes integrated line monitoring.

15. The wind turbine as claimed in claim 14, wherein the sensor includes a signal input for receiving information with respect to the line monitoring.

16. The wind turbine as claimed in claim 13, wherein the control unit includes a first signal input for a sensor line and a second signal input for line monitoring.

17. The wind turbine as claimed in claim 13, wherein a third line connecting the control unit to the disconnection element includes integrated line monitoring.

18. The wind turbine as claimed in claim 13,
further comprising a brake for the wind turbine, and
wherein a fourth line connecting the control unit to the brake includes integrated line monitoring.

19. The wind turbine as claimed in claim 13, wherein the line monitoring includes an integrated sensor.

20. The wind turbine as claimed in claim 19, wherein the integrated sensor includes a conductive layer which is wound in the form of a spiral around a line core and with an insulator arranged between line core and conductive layer.

21. The wind turbine as claimed in claim 19, wherein the integrated sensor measures data including voltage, current, frequency of three phases, and temperature.

22. The wind turbine as claimed in claim 13, wherein the first line connects the control unit to the generator coil and comprises a part of the high-voltage line.

23. The wind turbine as claimed in claim 13, wherein the high-voltage line from the generator coil up to the disconnection element features integrated line monitoring.

24. The wind turbine as claimed in claim 13, further comprising three generator coils and three high-voltage lines, each with a disconnection element.

25. The wind turbine as claimed in claim 13, wherein the sensor delivers data to the control unit including wind speed, a direction of the wind adjustment system, rotational speed of a shaft, and temperatures of transmission oil and transmission bearings.

26. The wind turbine as claimed in claim 14, wherein the second line includes an input line, an output line and an intermediate line.

27. The wind turbine as claimed in claim 26, wherein the output line is used for transmission of data from the control unit to the sensor.

28. The wind turbine as claimed in claim 13, wherein the data from the sensor is encoded.

29. A status monitoring system for a wind turbine, comprising:
a control unit;
a sensor connected to the control unit;
a disconnection element, controlled by the control unit which depends on the sensor, disposed in a high-voltage line from a generator coil to a power network; and
a first line connecting the control unit with the generator coil includes integrated line monitoring.

30. The status monitoring system as claimed in claim 29, further comprising a second line connecting the control unit to the sensor which includes integrated line monitoring.

31. The status monitoring system as claimed in claim 29, wherein a third line connecting the control unit to the disconnection element includes integrated line monitoring.
